(19) United States
(12) Patent Application Publication
(10) Pub. No.: US 2025/0104212 A1
(43) Pub. Date: Mar. 27, 2025

(54) PROCESSING DEVICE, PROCESSING SYSTEM, HANDLING SYSTEM, PROCESSING METHOD, AND STORAGE MEDIUM

(71) Applicant: KABUSHIKI KAISHA TOSHIBA, Tokyo (JP)

(72) Inventors: Kazuhide SAWA, Kawasaki (JP); Seiji TOKURA, Kawasaki (JP); Kazuma HIRAGURI, Yokohama (JP); Harutoshi CHATANI, Yokohama (JP); Akihito OGAWA, Fujisawa (JP)

(73) Assignee: KABUSHIKI KAISHA TOSHIBA, Tokyo (JP)

(21) Appl. No.: 18/830,686

(22) Filed: Sep. 11, 2024

(30) Foreign Application Priority Data
Sep. 22, 2023 (JP) 2023-157978
Aug. 14, 2024 (JP) 2024-135452

(51) Int. Cl. G06T 7/00; B25J 9/16; G06T 7/70; G06V 20/52

(52) U.S. Cl. CPC G06T 7/0004; B25J 9/1697; G06T 7/70; G06V 20/52; G06T 2207/30232; G06V 2201/06

(57) ABSTRACT

According to one embodiment, a processing device is configured to obtain first events indicating that a holding part of a handling robot has passed through respective predetermined passing-through positions. The processing device is configured to obtain a plurality of images of the handling robot. The processing device is configured to identify, when obtaining a second event indicating an abnormality in the handling robot, a first period that is between two of the plurality of first events and includes occurrence timing of the second event, or a second period that is from one of the plurality of first events immediately before the occurrence timing to the occurrence timing. The processing device is configured to extract at least one of the plurality of images obtained in the first period or the second period from the plurality of images.

### CROSS-REFERENCE TO RELATED APPLICATIONS

This application is based upon and claims the benefits of priority from Japanese Patent Application No. 2023-157978, filed on Sep. 22, 2023, and Japanese Patent Application No. 2024-135452, filed on Aug. 14, 2024; the entire contents of which are incorporated herein by reference.

### FIELD

Embodiments of the invention generally relate to a processing device, a processing system, a handling system, a processing method, and a storage medium.

### BACKGROUND

Handling robots that convey items are available. There is a demand for a technique for, upon the occurrence of an abnormality in such a handling robot, enabling easy checking of the state of, for example, the handling robot or an item.

### BRIEF DESCRIPTION OF THE DRAWINGS

FIG. 1 is a schematic diagram illustrating a handling system including a processing device according to an embodiment;

FIG. 2 is a schematic diagram showing an example of a handling robot;

FIG. 3A and FIG. 3B are schematic diagrams for explaining processing by the handling system according to the embodiment;

FIG. 4A and FIG. 4B are schematic diagrams for explaining the processing by the handling system according to the embodiment;

FIG. 5A and FIG. 5B are schematic diagrams for explaining the processing by the handling system according to the embodiment;

FIG. 6 is a schematic diagram for explaining processing by the processing device according to the embodiment;

FIG. 7 is a schematic diagram for explaining processing by the processing device according to the embodiment;

FIG. 8 is a schematic diagram for explaining processing by the processing device according to the embodiment;

FIG. 9 is a schematic diagram showing example display by a terminal device;

FIG. 10 is a schematic diagram showing example display by the terminal device;

FIG. 11 is a flowchart showing a processing method according to the embodiment;

FIG. 12 is a schematic diagram showing example display by the terminal device;

FIG. 13 is a schematic diagram for explaining processing by the processing device according to the embodiment;

FIG. 14 is a schematic diagram for explaining the processing by the processing device according to the embodiment;

FIG. 15 is a schematic diagram showing another example of the handling robot; and

FIG. 16 is a schematic diagram showing a hardware configuration.

### DETAILED DESCRIPTION

According to one embodiment, a processing device is configured to obtain a plurality of first events indicating that a holding part of a handling robot has passed through respective predetermined passing-through positions. The processing device is configured to obtain a plurality of images of the handling robot. The processing device is configured to identify, when obtaining a second event indicating an abnormality in the handling robot, a first period that is between two of the plurality of first events and includes occurrence timing of the second event, or a second period that is from one of the plurality of first events immediately before the occurrence timing to the occurrence timing. The processing device is configured to extract at least one of the plurality of images obtained in the first period or the second period from the plurality of images.

Hereinafter, embodiments of the invention will be described with reference to the drawings. The drawings are schematic or conceptual, and the relationship between the thickness and width of each portion, the proportions of sizes among portions, and the like are not necessarily the same as the actual values. Even the dimensions and proportion of the same portion may be illustrated differently depending on the drawing. In the specification and drawings, components similar to those already described are marked with like reference numerals, and a detailed description is omitted as appropriate.

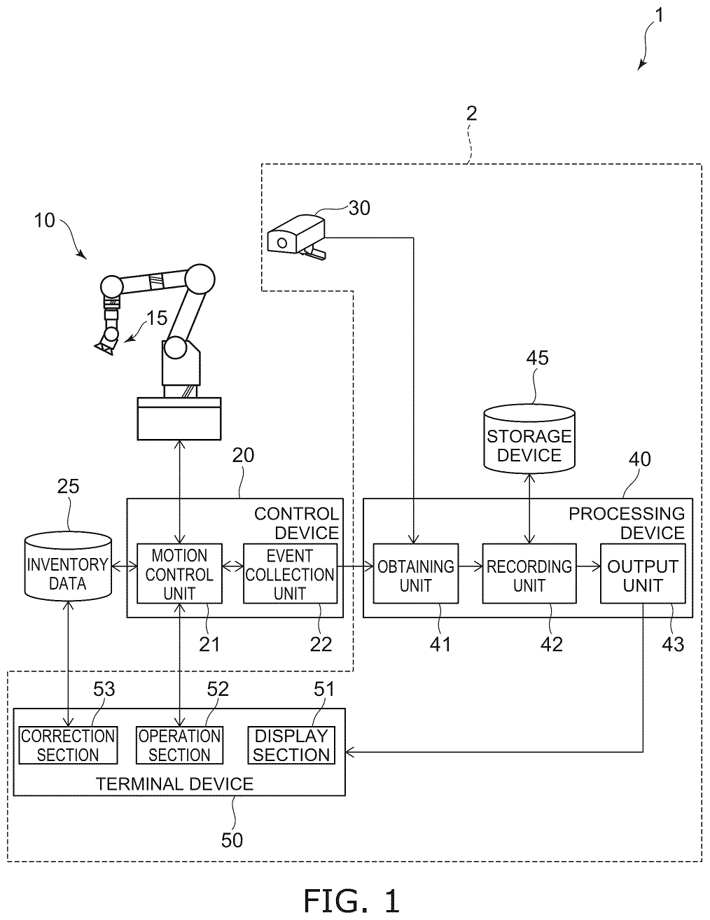

FIG. 1 is a schematic diagram illustrating a handling system including a processing device according to an embodiment.

As shown in FIG. 1, a handling system 1 according to the embodiment includes a handling robot 10, a control device 20, a photographing device 30, a processing device 40, and a terminal device 50.

The handling robot 10 includes a holding part 15 for holding an item, and uses the holding part 15 to convey an item. The holding part 15 holds an item by, for example, sucking or pinching. In the illustrated example, the handling robot 10 is a vertical articulated picking robot. The picking robot carries out picking tasks. More specifically, an instruction for a picking task is transmitted to the picking robot from a higher-level computer. The instruction includes items to be picked and the number of the items. Near the picking robot, a container is disposed by a person or another conveying robot. In the container, specified items are stored. The picking robot conveys the specified items from the container to another container or a device (for example, a belt conveyor).

The control device 20 has the functions of a motion control unit 21 and an event collection unit 22. The motion control unit 21 controls the motion of the handling robot 10. Specifically, the motion control unit 21 generates a motion plan and moves the handling robot 10 in accordance with the motion plan. The motion plan includes an item to be conveyed, a holding position, a passing-through position, a releasing position, a holding power for the item, a holding method for the item, a conveyance speed for the item, and so on.

The “holding position” is the position of the holding part 15 when the item is held. The “passing-through position” is a position that the holding part 15 passes through during the motion of the handling robot 10. The “releasing position” is a position at which the item held by the holding part 15 is released. The “holding power” is a power necessary for holding the conveyed item. The “holding method” indicates, when the holding part 15 has a plurality of methods for holding items, which of the methods is to be used to hold the item. The “conveyance speed” is the speed of the holding part 15 when the handling robot 10 conveys the item.

Upon generation of the motion plan, the motion control unit 21 refers to inventory information registered in inventory data 25. The inventory information includes the storage location of each item, the quantity of inventory of each item, and so on.

The event collection unit 22 generates and collects events during the motion of the handling robot 10. For example, when the holding part 15 has passed through the passing-through position or when an abnormality has occurred in the handling robot 10, the event collection unit 22 generates an event.

The photographing device 30 repeatedly photographs the handling robot 10 to obtain images. The photographing device 30 may successively photograph the handling robot 10 to obtain a moving image. The photographing device 30 preferably photographs the handling robot 10 from above such that the holding part 15, the conveyed item, and so on are easily included in the image.

The processing device 40 has the functions of an obtaining unit 41, a recording unit 42, and an output unit 43. The obtaining unit 41 obtains an event generated by the event collection unit 22 and images obtained by the photographing device 30. The recording unit 42 records the obtained images and the obtained event in a storage device 45. The output unit 43 extracts and outputs, to the terminal device 50, some of the recorded images in accordance with the obtained event.

The terminal device 50 has the functions of a display section 51, an operation section 52, and a correction section 53. The display section 51 is a function for displaying an image output from the output unit 43. The operation section 52 is a function for the user of the terminal device 50 to operate the motion control unit 21. The correction section 53 is a function for the user of the terminal device 50 to correct data in the inventory data 25. For example, the user of the terminal device 50 is an operator monitoring the handling robot 10.

The control device 20 is connected to the handling robot 10 and the processing device 40 through wired communication or wireless communication. The terminal device 50 is connected to the control device 20 and the processing device 40 via a network. The photographing device 30 transmits obtained images to the processing device 40 through wired communication or wireless communication. Alternatively, the photographing device 30 may 20 save obtained images on a server on a network, and the processing device 40 may obtain the images saved on the server.

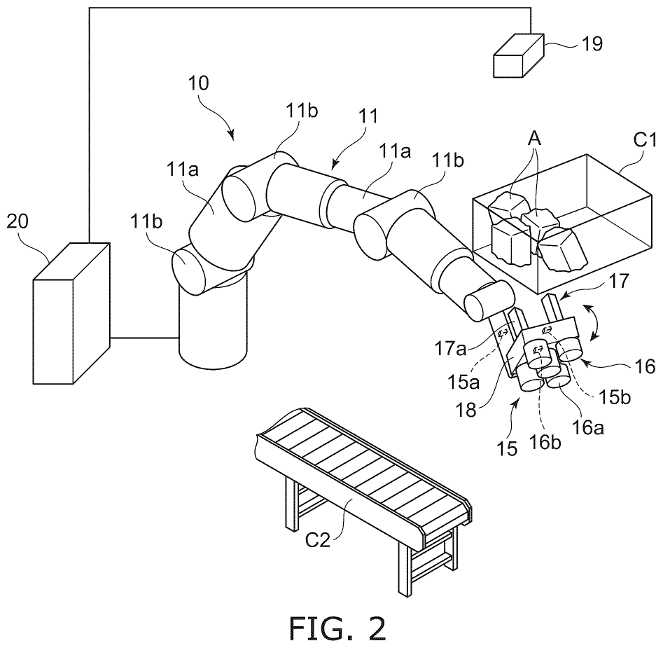

FIG. 2 is a schematic diagram showing an example of the handling robot.

As shown in FIG. 2, for example, the handling robot 10 is a vertical articulated robot. The handling robot 10 includes a manipulator 11 that includes a plurality of links 11a and a plurality of rotating shafts 11b. Each rotating shaft 11b couples corresponding ones of the links 11a. When each rotating shaft 11b moves, the position and angle of the distal end of the 30 manipulator 11 change. The distal end of the manipulator 11 preferably has six degrees of freedom.

The holding part 15 is attached to the distal end of the manipulator 11. In the illustrated example, the holding part 15 includes a suction mechanism 16 and a pinching mechanism 17.

The suction mechanism 16 holds an item by suction. Specifically, the suction mechanism 16 includes one or more suction pads 16a. In the state in which the suction pads 16a are in contact with an item, the inside of the suction pads 16a is decompressed by a decompression device not illustrated. Accordingly, the suction pads 16a suck the item. The number of the suction pads 16a may be smaller or larger than in the illustrated example.

The pinching mechanism 17 holds an item by pinching. Specifically, the pinching mechanism 17 includes a plurality of rod-shaped supporting parts 17a. An item is pinched between the plurality of supporting parts 17a and is held. The pinching mechanism 17 may include a larger number of the supporting parts 17a than in the illustrated example. Each supporting part 17a may be formed in the form of a finger including one or more joints.

The holding part 15 further includes a switching mechanism 18. The suction mechanism 16 and the pinching mechanism 17 are coupled to the switching mechanism 18. The switching mechanism 18 turns the suction mechanism 16 and the pinching mechanism 17 to switch the mechanism to be used in holding an item.

The holding part 15 is not limited to the illustrated example and may include only one of the suction mechanism 16 or the pinching mechanism 17. In this case, the switching mechanism 18 is not necessary. Alternatively, the holding part 15 may include another holding mechanism in addition to the suction mechanism 16 and the pinching mechanism 17.

In an example, a container C1 and a conveyor C2 are disposed near the handling robot 10. The handling robot 10 holds an item A stored in the container C1 and conveys the item A onto the conveyor C2. The conveyor C2 conveys the conveyed item to a predetermined location.

A detector 19 for detecting the state of the inside of the container C1 may be provided. The detector 19 detects an item stored in the container C1. The detector 19 includes one or more selected from among a camera and a range sensor. The item is recognized from a color image obtained by the camera or a range image obtained by the range sensor. Based on the result of recognition, the position, size, form, and so on of the item are calculated. The position, size, form, and so on may be calculated by a computer provided in the detector 19 or may be calculated by the control device 20. The detector 19 is provided, for example, above the container C1. Alternatively, the detector 19 may be attached to the manipulator 11.

When generating a motion plan, the motion control unit 21 may obtain one or more pieces of item data selected from among the size of the item, the form of the item, the weight of the item, and the material of the item and may change, on the basis of the one or more pieces of item data, at least any selected from among the holding power for the item, the holding method for the item, and the conveyance speed for the item. For example, as the weight increases, the holding power is set to a larger value. A small item is held by pinching, and a large item is held by suction. An item having a smooth surface is held by suction. An item having an irregular surface is held by pinching. As an item is heavier, the conveyance speed is set to a lower value. When the holding power, the holding method, or the conveyance speed is changed, the item can be held more stably.

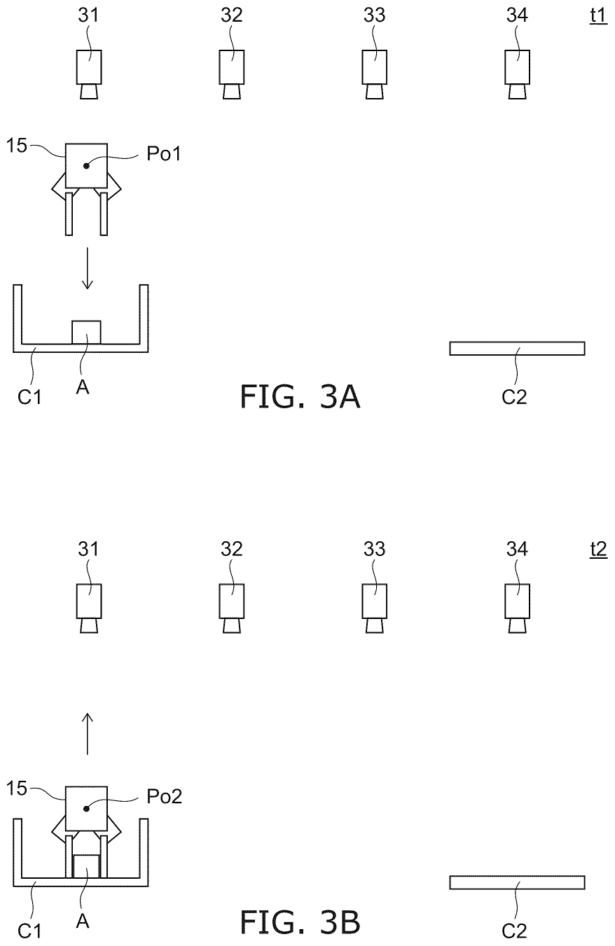

FIG. 3A to FIG. 5B are schematic diagrams for explaining processing by the handling system according to the embodiment.

When the handling robot 10 conveys an item, the motion control unit 21 moves the handling robot 10 to move the holding part 15 to a position Po1 above the item A as shown in FIG. 3A. Next, the motion control unit 21 moves the holding part 15 to a position Po2 for holding the item A as shown in FIG. 3B. The motion control unit 21 makes the holding part 15 hold the item A at the position Po2, and moves the holding part 15 upward.

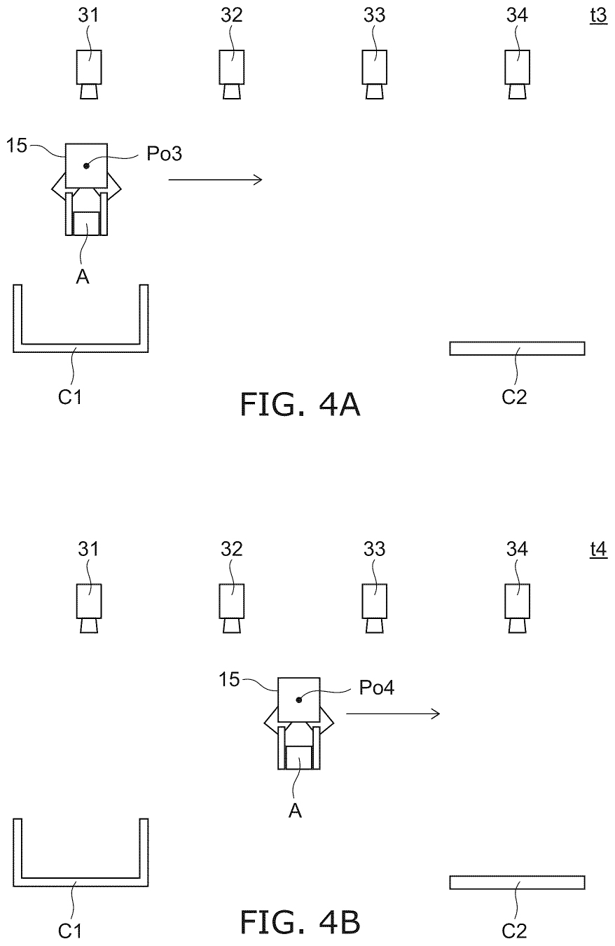

The motion control unit 21 moves the holding part 15 to a position Po3 as shown in FIG. 4A. The position Po3 may be the same as the position Po1. Subsequently, the motion control unit 21 moves the holding part 15 toward the conveyor C2. At this time, the holding part 15 passes through a position Po4 calculated in advance, as shown in FIG. 4B.

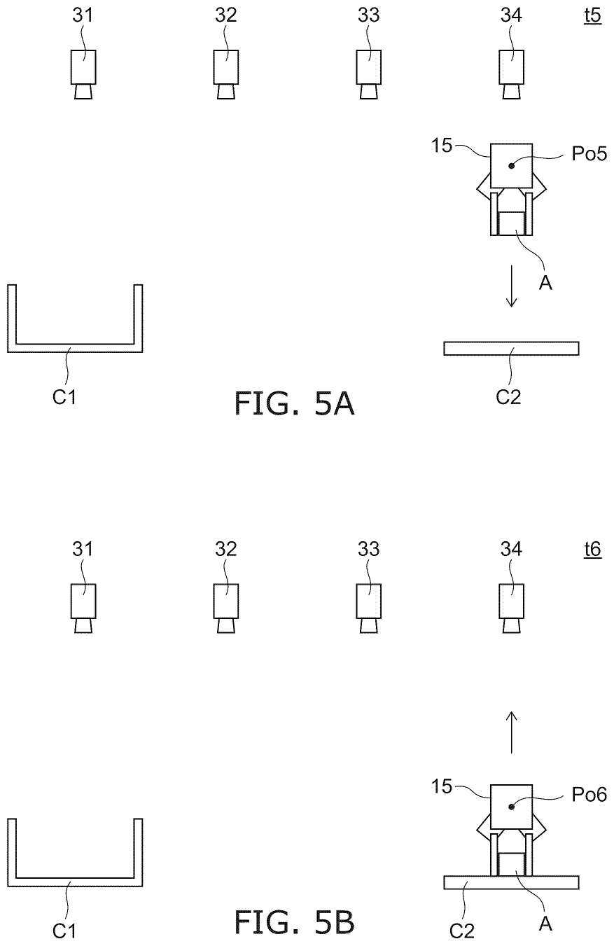

The motion control unit 21 moves the holding part 15 to a position Po5 above the conveyor C2 as shown in FIG. 5A. Subsequently, the motion control unit 21 moves the holding part 15 to a position Po6 for placing the item A as shown in FIG. 5B. The motion control unit 21 makes the holding part 15 release the item A at the position Po6, and moves the holding part 15 upward.

In the series of motions shown in FIG. 3A to FIG. 5B, the positions Po1 to Po6 that the holding part 15 passes through are calculated in advance by the motion control unit 21 and are included in the motion plan. The positions Po1 and Po3 to Po5 are examples of the passing-through position. The position Po2 is an example of the holding position. The position Po6 is an example of the releasing position.

In the illustrated example, cameras 31 to 34 are provided above the movement path of the holding part 15. Each of the cameras 31 to 34 is an example of the photographing device 30. The cameras 31 to 34 photograph different areas. Specifically, the camera 31 is provided above the container C1 and photographs an area including the positions Po1 to Po3. The camera 32 and the camera 33 photograph an area between the position Po3 and the position Po5. The camera 34 photographs an area including the positions Po5 and Po6. The cameras 31 to 34 repeatedly obtain images during the motion of the handling robot 10, regardless of whether the holding part 15 is present in any of the photographing areas.

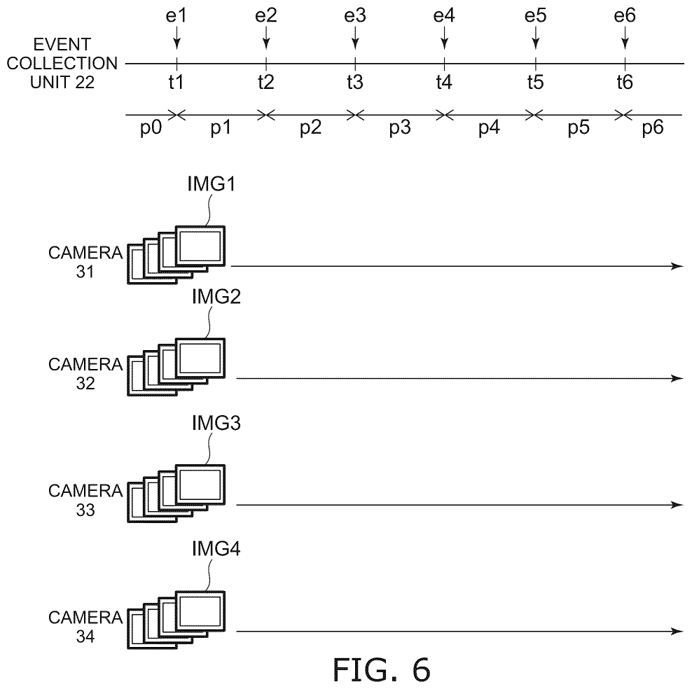

FIG. 6 is a schematic diagram for explaining processing by the processing device according to the embodiment.

In the motion shown in FIG. 3A and FIG. 3B, the holding part 15 reaches the position Po1 at a timing t1 and reaches the position Po2 at a timing t2. Next, in the motion shown in FIG. 4A and FIG. 4B, the holding part 15 reaches the position Po3 at a timing t3 and reaches the position Po4 at a timing t4. Thereafter, in the motion shown in FIG. 5A and FIG. 5B, the holding part 15 reaches the position Po5 at a timing t5 and reaches the position Po6 at a timing t6.

As shown in FIG. 6, the event collection unit 22 collects the fact that the holding part 15 has passed through any of the positions Po1 to Po6 as a first event e1, e2, e3, e4, e5, or e6. The first events e1 to e6 are generated at the timings t1 to t6 respectively. The camera 31 obtains a plurality of images IMG1 (a moving image) by repeated photographing during the motion of the holding part 15. Similarly, the cameras 32 to 34 obtain a plurality of images IMG2, a plurality of images IMG3, and a plurality of images IMG4 respectively. The obtaining unit 41 obtains the first events e1 to e6 from the event collection unit 22 and obtains the plurality of images IMG1, the plurality of images IMG2, the plurality of images IMG3, and the plurality of images IMG4 from the cameras 31 to 34.

As shown in FIG. 6, the recording unit 42 may identify each of periods p0 to p6 between corresponding ones of the timings at which the respective first events occur. The recording unit 42 may assign, to each obtained image, a label indicating the period in which the image is captured. When the label is assigned, each image is associated with the period between corresponding ones of the first events. When the cameras 31 to 34 each obtain successive images (a moving image), a common label is assigned to a plurality of images (a portion of the moving image). The recording unit 42 records the images that are assigned the labels, in the storage device 45.

The event collection unit 22 generates a second event when an abnormality has occurred in the handling robot 10, in addition to the first events. For example, an “abnormality” indicates the occurrence of an event that is not included in the motion plan. For example, when the item held by the holding part 15 has dropped or when the holding part 15 has come into contact with an object other than the held item, a second event is generated.

The details of the abnormality are inferred by the control device 20. For example, a negative pressure sensor 16b is provided inside the suction pad 16a as shown in FIG. 2. The negative pressure sensor 16b detects the difference (negative pressure) between the pressure in the interior space of the suction pad 16a and the atmospheric pressure. When an item is held by the suction mechanism 16, if a pressure detected by the negative pressure sensor 16b falls below a preset threshold value, the control device 20 infers that the item has dropped. When an item is held by the pinching mechanism 17, if a force applied to the supporting parts 17a rapidly decreases, the control device 20 infers that the item has dropped. The force applied to the supporting parts 17a is calculated on the basis of, for example, the current value of a motor that drives the supporting parts 17a. Alternatively, a sensor for detecting the force applied to the supporting parts 17a may be provided. When a force sensor 15a provided in the handling robot 10 detects an impact, the control device 20 infers that the holding part 15 has come into contact with an object other than the item.

When a second event indicating a drop of the item is obtained, the recording unit 42 identifies a first period, between first events, including the occurrence timing of the second event. When a second event indicating a contact of the holding part 15 with an object is obtained, the recording unit 42 identifies a second period from a first event immediately before the occurrence timing of the second event to the occurrence timing of the second event.

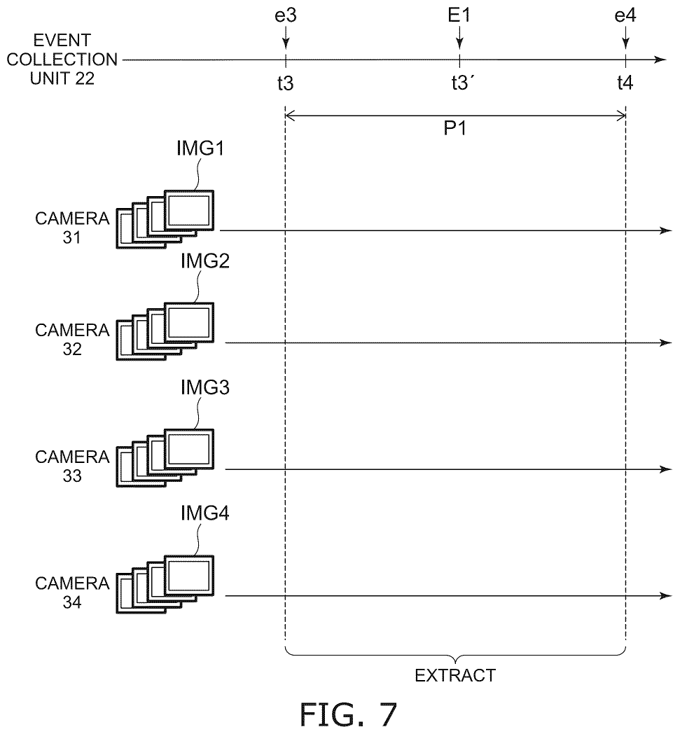

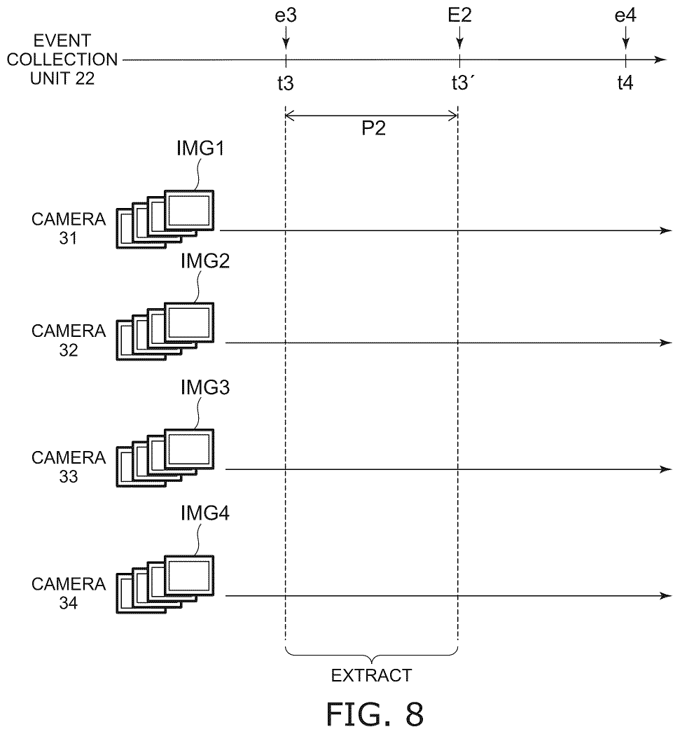

FIG. 7 and FIG. 8 are schematic diagrams for explaining processing by the processing device according to the embodiment.

In an example, an item held by the holding part 15 drops in the period during which the holding part 15 moves from the position Po3 shown in FIG. 4A to the position Po4 shown in FIG. 4B. In this case, as shown in FIG. 7, a second event E1 indicating the drop of the item is generated at a timing t3′ between the timing t3 and the timing t4. Even when the item has dropped, the control device 20 moves the holding part 15 to the position Po4.

The recording unit 42 identifies a first period P1 from the first event e3 (timing t3) immediately before the timing t3′ to the first event e4 (timing t4) immediately after the timing t3′. The recording unit 42 extracts an image obtained in the first period P1, from the plurality of images IMG1 obtained by the camera 31. Similarly, the recording unit 42 extracts images obtained in the first period P1, from the plurality of images IMG2 to IMG4 obtained by the cameras 32 to 34.

In another example, the holding part 15 comes into contact with another unintended object in the period during which the holding part 15 moves from the position Po3 to the position Po4. In this case, as shown in FIG. 8, a second event E2 indicating the contact of the holding part 15 with the other object occurs at a timing t3′ between the timing t3 and the timing t4. When the holding part 15 has come into contact with the other object, the control device 20 stops the motion of the handling robot 10.

The recording unit 42 identifies a second period P2 from the first event e3 (timing t3) immediately before the timing t3′ to the timing t3′. The recording unit 42 extracts images obtained in the second period P2, from the plurality of images IMG1 to IMG4 obtained by the cameras 31 to 34.

The output unit 43 outputs the one or more extracted images to the terminal device 50. The display section 51 displays the received images so as to be viewable to the user of the terminal device 50. The operation section 52 operates the control device 20 in accordance with input to the terminal device 50 from the user. The correction section 53 corrects the inventory data 25 in accordance with input to the terminal device 50 from the user. The user can operate the control device 20 or correct the quantity of inventory registered in the inventory data 25 while checking the images displayed by the display section 51, by using the function of the operation section 52 or the correction section 53.

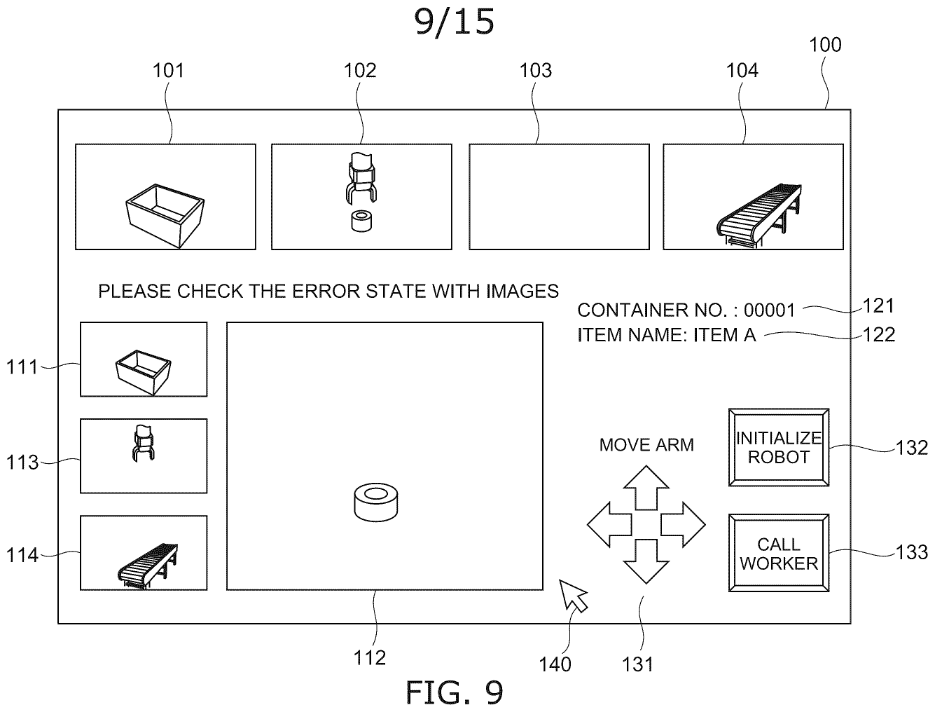

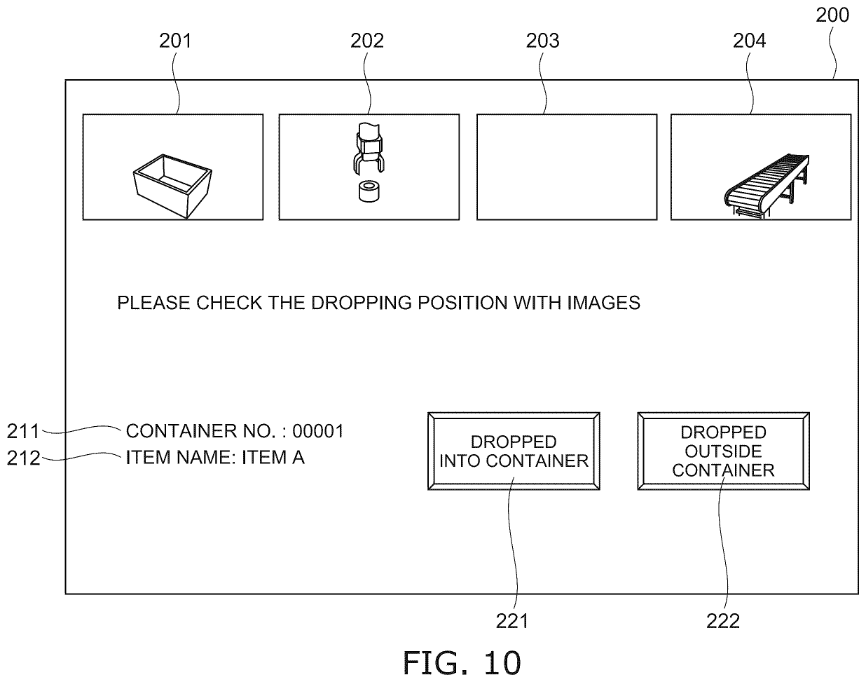

FIG. 9 and FIG. 10 are schematic diagrams showing example display by the terminal device.

The terminal device 50 provides the functions of the operation section 52 and the correction section 53 to the user through a graphical user interface (GUI). The display section 51 displays, for example, a GUI 100 shown in FIG. 9. On the GUI 100, images 101 to 104, live images 111 to 114, container information 121, item information 122, and icons 131 to 133 are displayed. The icon 131 and the icon 132 are examples of the operation section 52.

The images 101 to 104 are images respectively obtained by the cameras 31 to 34 at the timing of the occurrence of the second event. Here, an example case where the item has dropped is illustrated. The images 101 to 104 are extracted by the recording unit 42. When a plurality of images are extracted from images obtained by one camera, the plurality of images may be displayed in a switched manner at predetermined intervals. When the cameras obtain moving images, moving images extracted by the recording unit 42 may be displayed as the images 101 to 104.

The live images 111 to 114 are real-time images obtained by the cameras 31 to 34 respectively. For example, one of the live images 111 to 114 is displayed larger in size than the others of the live images 111 to 114. When the user selects any of the live images 111 to 114 with a pointer 140, the selected image can be enlarged.

The container information 121 is information regarding the container in which the conveyed item has been stored. The item information 122 is information regarding the conveyed item.

The icon 131 is displayed for moving the arm of the handling robot 10. When the user clicks on any of the arrows of the icon 131 with the pointer 140, the holding part 15 can be moved in the direction indicated by the arrow. The icon 132 is displayed for initializing the handling robot 10. In response to a click on the icon 132, the motion of the control device 20 is initialized, and identification of the abnormality by the control device 20 is removed. The motion control unit 21 resumes the motion of the handling robot 10 in accordance with a motion plan generated immediately before. The icon 133 is an icon for calling the worker to the installation place of the handling robot 10. For example, in response to a click on the icon 133, a notification is transmitted to a specific terminal device. In response to the notification, the worker moves to the installation place of the handling robot 10 and examines the handling robot 10.

The display section 51 displays a GUI 200 shown in FIG. 10 separately from the GUI 100. On the GUI 200, images 201 to 204, container information 211, item information 212, an icon 221, and an icon 222 are displayed. The icon 221 and the icon 222 are examples of the correction section 53.

The images 201 to 204 are images respectively obtained by the cameras 31 to 34 at the timing of the occurrence of the second event. As each of the images 201 to 204, a plurality of images that are sequentially switched or a moving image may be displayed. The container information 211 is information regarding the container in which the conveyed item has been stored. The item information 212 is information regarding the conveyed item.

The icon 221 and the icon 222 are displayed for correcting the quantity of inventory of the item. The icon 221 is selected when the item has dropped into a container (or onto the conveyor). When an item has dropped into the container that is the point of origin of conveyance, the item can be conveyed to the conveyor by the handling robot 10. When an item has dropped onto the conveyor that is the destination of conveyance, the conveyance of the item can be considered to be completed. Therefore, the quantity of inventory of the item need not be corrected. When the user clicks on the icon 221, the quantity of inventory registered in the inventory data 25 is not changed.

The icon 222 is selected when the item has dropped onto other than the container (or the conveyor). When an item has dropped onto other than the container or the conveyor, the item is unable to be conveyed to the conveyor until the item is retrieved and stored in the container. That is, the quantity of inventory of the conveyed item decreases. In the case of a click on the icon 222, the number of dropping items is subtracted from the quantity of inventory recorded in the inventory data 25.

When an item dropping onto the container or the conveyor is damaged, the item is not allowed to be shipped. Therefore, when the item dropping onto the container or the conveyor is damaged, the icon 222 is selected, and the quantity of inventory is decreased. Whether an item dropping onto the container or the conveyor is damaged can be checked from any of the images 201 to 204.

The user of the terminal device 50 operates the control device 20 or corrects the inventory information in the inventory data 25 as appropriate while switching between the GUI 100 and the GUI 200.

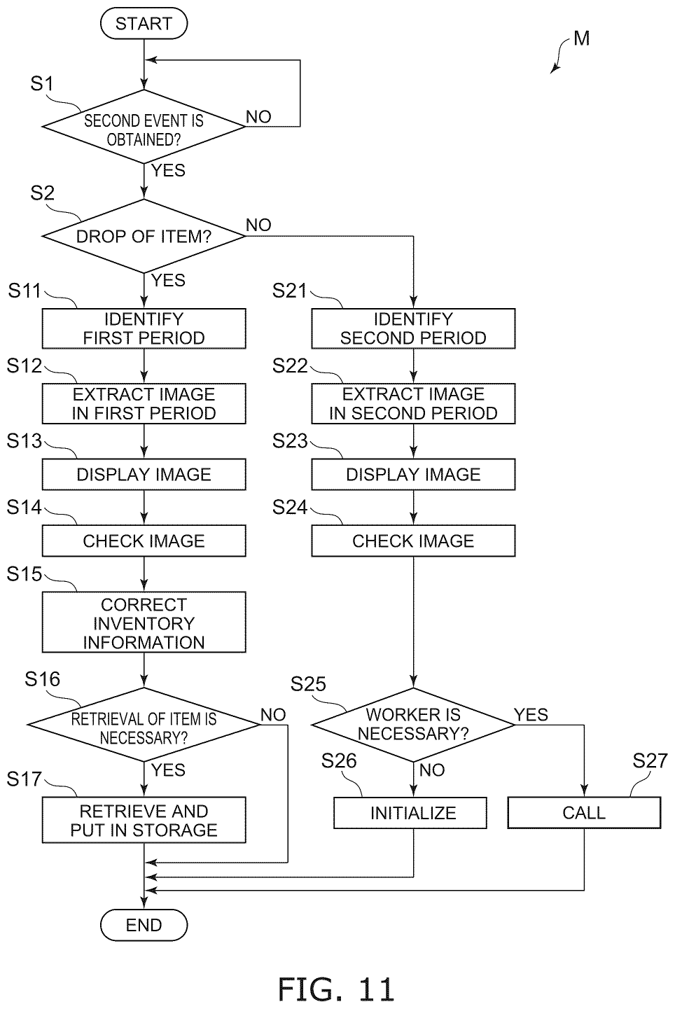

FIG. 11 is a flowchart showing a processing method according to the embodiment.

A processing method M shown in FIG. 11 is performed when a second event occurs in the handling system 1. First, the recording unit 42 determines whether a second event is obtained by the obtaining unit 41 (step S1). Step S1 is repeated until a second event is obtained. If a second event is obtained, the recording unit 42 determines the details of an abnormality indicated by the second event. For example, the recording unit 42 determines whether the abnormality indicated by the obtained second event is a drop of an item (step S2).

If the abnormality is a drop of an item, the recording unit 42 identifies a first period from a first event immediately before the occurrence timing of the second event to a first event immediately after the occurrence timing (step S11). The recording unit 42 extracts an image obtained by the photographing device 30 in the first period (step S12). The output unit 43 outputs the extracted image to the terminal device 50, and the display section 51 displays the image (step S13). The user of the terminal device 50 checks the displayed image (step S14). The user corrects the inventory information of the item as necessary by using the correction section 53 (step S15). Further, the user determines whether retrieval of the dropping item is necessary (step S16). If it is determined that the retrieval is necessary, the user makes their way to retrieve the item. Alternatively, the user calls the worker. The user or the worker retrieves the item and puts the item in storage (step S17). If it is determined in step S16 that the retrieval is not necessary or when step S17 is completed, the processing method M ends. With the above-described steps, a recovery process when an item drops is completed.

If the abnormality is other than a drop of an item, the recording unit 42 identifies a second period from a first event immediately before the occurrence timing of the second event to the occurrence timing of the second event (step S21). The recording unit 42 extracts an image obtained by the photographing device 30 in the second period (step S22). The output unit 43 outputs the extracted image to the terminal device 50, and the display section 51 displays the image (step S23). The user of the terminal device 50 checks the displayed image (step S24). The user determines, from the image, whether the worker is necessary for recovery from the abnormality (step S25). If it is determined that the worker is not necessary, the user initializes the handling robot 10 by using the operation section 52 (step S26). Accordingly, the motion of the handling robot 10 is resumed. If it is determined that the worker is necessary, the user calls the worker (step S27). The worker heads for the installation place of the handling robot 10 and, for example, checks and restores the handling robot 10. When step S26 or S27 is completed, the processing method M ends. With the above-described steps, a recovery process when an abnormality other than a drop of an item occurs is completed.

The advantages of the embodiment will be described.

An abnormality may occur during the motion of the handling robot 10. Examples of the abnormality include a drop of an item and a contact of the holding part 15 with an unintended object. When an abnormality occurs, the dropping item or the handling robot 10 needs to be checked. It is a common practice for the worker to, upon the occurrence of an abnormality, move to the installation place of the handling robot 10 and check the item, the handling robot 10, and so on. With this method, however, recovery from the abnormality in the handling robot 10 takes long.

In the case of a drop of an item, the motion by the handling robot 10 can be resumed without checking the details. In this case, however, the inventory information registered in the inventory data 25 may become different from the actual inventory information. For example, when an item drops onto the container that is the point of origin of conveyance or the location of the destination of conveyance but the quantity of inventory in the inventory data 25 is decreased, the quantity of inventory in the inventory data 25 becomes less than the actual quantity of inventory. When an item drops onto other than the container that is the point of origin of conveyance or the location of the destination of conveyance while the quantity of inventory in the inventory data 25 is not decreased, the actual quantity of inventory becomes less than the quantity of inventory in the inventory data 25.

For these issues, the processing device 40 according to the embodiment obtains events from the event collection unit 22 and obtains images from the photographing device 30. The events transmitted from the event collection unit 22 include first events and a second event. The first events each indicate that the holding part 15 of the handling robot 10 has passed through a corresponding one of the predetermined passing-through positions. The second event indicates that an abnormality has occurred in the handling robot 10. When obtaining the second event, the processing device 40 identifies a first period or a second period. The first period is a period, between first events, including the occurrence timing of the second event. The second period is a period from a first event immediately before the occurrence timing to the occurrence timing. The processing device 40 extracts an image obtained in the first period or the second period, from the plurality of images obtained by the photographing device 30.

For example, the operator monitoring the handling system 1 can easily check the state of, for example, the handling robot 10 or the item from the extracted image. When the item has dropped, the operator can easily determine whether the inventory information needs to be corrected, by checking the image. When the holding part 15 has come into contact with an unintended object, the operator can easily determine whether the worker needs to respond, by checking the image.

According to the embodiment of the invention, when an abnormality occurs in the handling robot 10, the state of, for example, the handling robot 10 or the item can be easily checked.

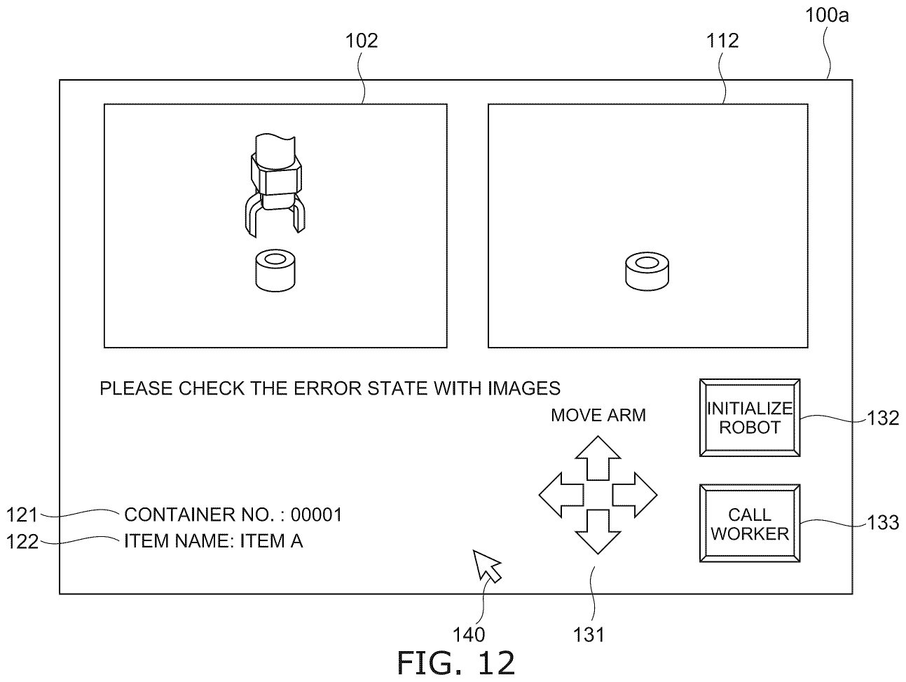

FIG. 12 is a schematic diagram showing example display by the terminal device.

When an area is estimated by the recording unit 42 with at least any of methods as described below, the terminal device 50 may display a GUI 100a shown in FIG. 12. On the GUI 100a, the image 102, the live image 112, the container information 121, the item information 122, and the icons 131 to 133 are displayed. Unlike the GUI 100, the images 101, 103, and 104 and the live images 111, 113, and 114 are not included in the GUI 100a.

In the example shown in FIG. 12, it is inferred that the holding part 15 is present in the photographing area of the camera 32 upon a drop of the item. As a result, the image 102 obtained by the camera 32 is extracted from the images 101 to 104 respectively obtained by the cameras 31 to 34 and is displayed. Further, the real-time live image 112 captured by the camera 32 is displayed.

As shown in FIG. 9, FIG. 10, and FIG. 12, the processing device 40 may display the container information and the item information on the terminal device 50 in addition to the extracted images. Accordingly, the operator can easily understand during conveyance of which item an abnormality occurs.

The terminal device 50 preferably has the function of the operation section 52. When the terminal device 50 has the function of the operation section 52, the operator can initialize the motion of the handling robot 10 in accordance with the result of checking the abnormality, without moving to the installation place of the handling robot 10. Further, the terminal device 50 preferably has the function of the correction section 53. When the terminal device 50 has the function of the correction section 53, the operator can correct the inventory information registered in the inventory data 25 as appropriate, in accordance with the result of checking the abnormality. With these functions, the convenience of the handling system 1 can be further improved.

A processing system 2 (shown in FIG. 1) including the photographing device 30, the processing device 40, and the terminal device 50 may be installed later for the existing handling robot 10 and the existing control device 20. When the photographing device 30 photographing the handling robot 10 is already installed, the photographing device 30 need not be installed later. When the processing system 2 is installed later for the existing handling robot 10 and the existing control device 20, a recovery process when an abnormality occurs in the handling robot 10 can be made easy.

When images are obtained by a plurality of photographing devices 30, the recording unit 42 may estimate an area in which the holding part 15 is present at the occurrence timing of the second event, from the photographing area of each photographing device 30. For example, coordinate data indicating the photographing area of each photographing device 30 is registered in advance in the storage device 45. The recording unit 42 estimates an area in which the holding part 15 is present upon the occurrence of the second event, on the basis of the passing-through positions, for the holding part 15, included in the motion plan, the received first events, and so on. In this case, the recording unit 42 extracts an image from the photographing device 30, among the plurality of photographing devices 30, photographing the estimated area. With this method, at the time point of the occurrence of the second event, images of other than the holding part 15 are less likely to be extracted, and an image of the holding part 15 is more likely to be extracted. The number of images to be checked by the operator decreases, and convenience can be improved.

When obtaining a second event indicating a drop of an item, the recording unit 42 may estimate an area in which the dropping item is present, from the photographing area of each photographing device 30. For example, the holding part 15 includes an acceleration sensor 15b as shown in FIG. 2. The acceleration sensor 15b detects an acceleration to which the holding part 15 is subjected. When an item drops, a force is applied to the holding part 15 in a direction opposite to the dropping direction of the item. The acceleration sensor 15b detects an acceleration caused by this force. From the data detected by the acceleration sensor 15b, the dropping direction of the item can be estimated. The recording unit 42 estimates the area in which the dropping item is present, from the photographing area of each photographing device 30. The recording unit 42 extracts an image from the photographing device 30, among the plurality of photographing devices 30, photographing the estimated area. With this method, an image in which the dropping item is present is more likely to be extracted. The number of images to be checked by the operator decreases, and the convenience of the handling system 1 can be improved.

When an area in which a dropping item is present is estimated, a sensor other than the acceleration sensor may be used. For example, pressure sensors are provided below the motion range of the holding part 15. A plurality of mat-type pressure sensors are arranged, and each pressure sensor detects a force applied to its mat. When an item drops and a pressure is detected by any of the pressure sensors, it is inferred that the item drops onto the mat of the pressure sensor. The recording unit 42 extracts an image from the photographing device 30, among the plurality of photographing devices 30, photographing the estimated mat.

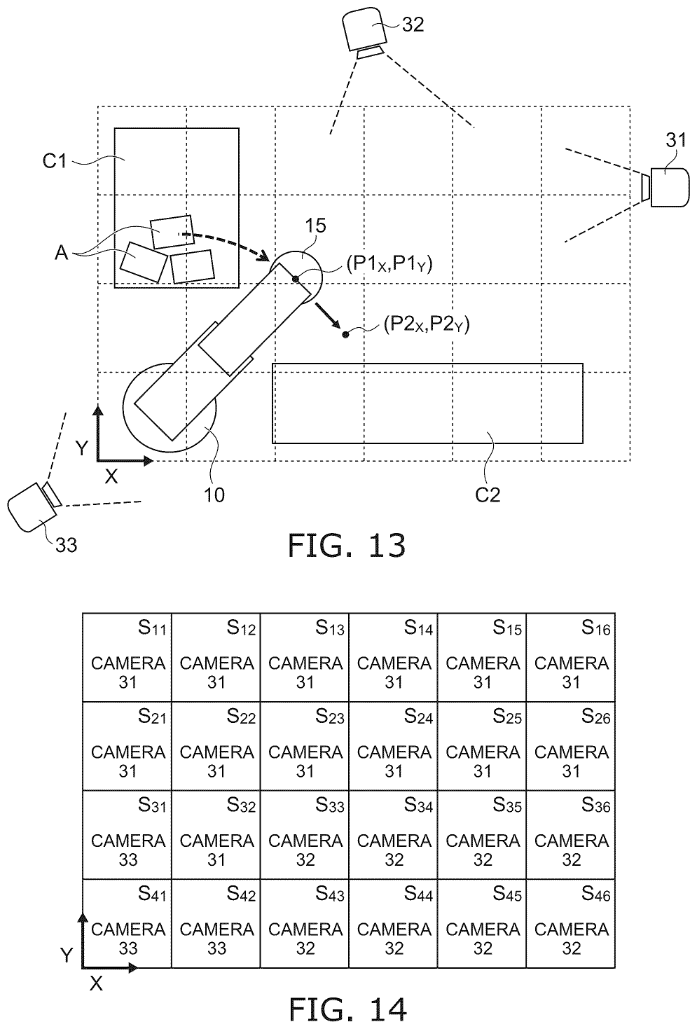

FIG. 13 and FIG. 14 are schematic diagrams for explaining processing by the processing device according to the embodiment.

In the example shown in FIG. 13, the cameras 31 to 33 are installed in the installation place of the handling robot 10. The cameras 31 to 33 photograph at least any of the handling robot 10, the container C1, or the conveyor C2 from different directions. The cameras 31 to 33 are preferably installed so as to eliminate blind spots.

In the installation place of the handling robot 10, a plurality of virtual sections are set in advance. For example, as shown in FIG. 14, 24(=4×6) sections S₁₁ to S₄₆ are set in the installation place. The plurality of sections are arranged along the X-direction and the Y-direction. Each section is associated with one of the cameras 31 to 33.

When obtaining a second event indicating a drop of an item, the recording unit 42 obtains an acceleration α_{X} of the item in the X-direction and an acceleration ay thereof in the Y-direction, from the result of detection by the acceleration sensor 15b. The recording unit 42 integrates each of the acceleration α_{X} and the acceleration α_{Y} with respect to time to calculate a velocity v_{X} of the dropping item in the X-direction and a velocity v_{Y} thereof in the Y-direction.

Next, the recording unit 42 calculates a dropping time t of the item. For example, a height is set in advance for each section. For a section in which, for example, the container C1 or the conveyor C2 is not placed, the height of the floor surface is set. For a section in which the container C1 is placed, the height of the bottom surface of the container C1 is set. For a section in which the conveyor C2 is placed, the height of the top surface of the conveyor C2 is set.

The recording unit 42 refers to a height h₁ of the holding part 15 upon the drop of the item. The recording unit 42 identifies a section in which the holding part 15 has been positioned upon the drop of the item and refers to a height h₂ of the section. The recording unit 42 calculates the dropping time t of the item on the basis of the height h₁ of the holding part 15, the height h₂ of the section, and a gravitational acceleration g.

The recording unit 42 refers to a position p1ₓ of the holding part 15 in the X-direction upon the drop of the item and a position ply of the holding part 15 in the Y-direction upon the drop of the item. The recording unit 42 integrates the velocity v_{X} in the X-direction and the dropping time t of the item to thereby calculate a moving distance d_{X} of the item in the X-direction during the drop. The recording unit 42 integrates the velocity v_{Y} in the Y-direction and the dropping time t of the item to thereby calculate a moving distance d_{Y} of the item in the Y-direction during the drop.

The recording unit 42 calculates a position p2_{X} of the dropping item in the X-direction and a position p2_{Y} thereof in the Y-direction from the position p1_{X} in the X-direction, the position ply in the Y-direction, the moving distance d_{X} in the X-direction, and the moving distance d_{Y} in the Y-direction. The recording unit 42 determines a section in which the position (p2_{X}, p2_{Y}) of the item is included. The recording unit 42 selects a camera associated with the determined section. The recording unit 42 extracts an image captured by the selected camera.

In the example shown in FIG. 13 and FIG. 14, it is determined that the item has dropped into the section S33. The section S33 is associated with the camera 32 by the recording unit 42. The recording unit 42 extracts an image captured by the camera 32.

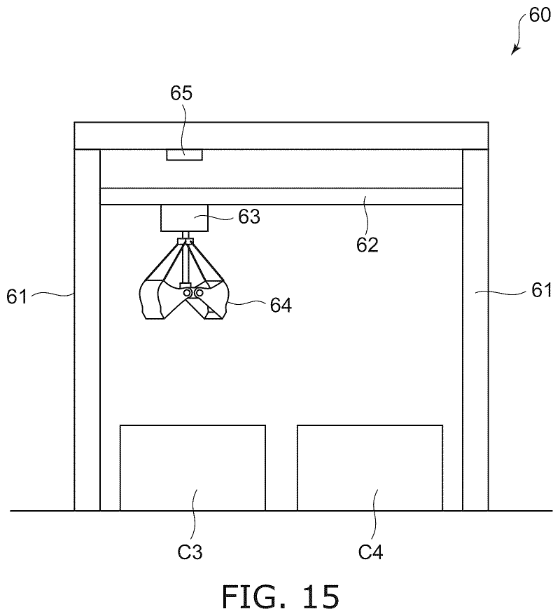

FIG. 15 is a schematic diagram showing another example of the handling robot.

A handling robot to which the embodiment of the invention is applied may be the picking robot described above or other than the picking robot. The embodiment of the invention may be applied to, for example, a handling robot 60 shown in FIG. 15.

The handling robot 60 is an automated crane. The handling robot 60 includes support columns 61, a rail 62, a hoist 63, a clamshell 64 (holding part), and a detector 65. The support columns 61 are rod-shaped members erected in the vertical direction. The rail 62 is provided along the horizontal direction and extends between the plurality of support columns 61. The rail 62 allows the hoist 63 to slide thereon in the horizontal direction. The clamshell 64 is hung from the hoist 63. The hoist 63 is capable of moving the clamshell 64 in the vertical direction.

The handling robot 60 holds an item stored in a container C3 with the clamshell 64 and conveys the item to a container C4. The handling robot 60 may be provided with, for example, a hook instead of the clamshell 64. The detector 65 detects the item stored in the container C3. The detector 65 includes one or more selected from among a camera and a range sensor.

The handling robot 60 is automatically operated by the motion control unit 21 shown in FIG. 1. The event collection unit 22 generates a first event each time the clamshell 64 passes through any of predetermined passing-through positions. Further, the event collection unit 22 generates a second event when an abnormality occurs in the handling robot 60. The photographing device 30 photographs the handling robot 60. The processing device 40 extracts an image in response to obtaining of a second event. When an abnormality occurs in the handling robot 60, the operator can check the extracted image on the terminal device 50.

The embodiment of the invention is suitable for picking robots. The sizes, forms, weights, and so on of items conveyed by a picking robot vary to a large degree among the items. Further, in general, items that are conveyed by a picking robot are irregularly stored in a container. That is, the positions of items in a container that is the point of origin of conveyance differ at different times. Therefore, in a picking robot, an abnormality occurs more frequently than in other handling robots. When the embodiment is applied to a picking robot, a recovery process can be made easier, and the operational efficiency of the picking robot can be improved.

One terminal device 50 may be connected to a plurality of processing devices 40 via a network. The plurality of processing devices 40 respectively obtain events from a plurality of control devices 20. Accordingly, one terminal device 50 can monitor a plurality of handling robots 10.

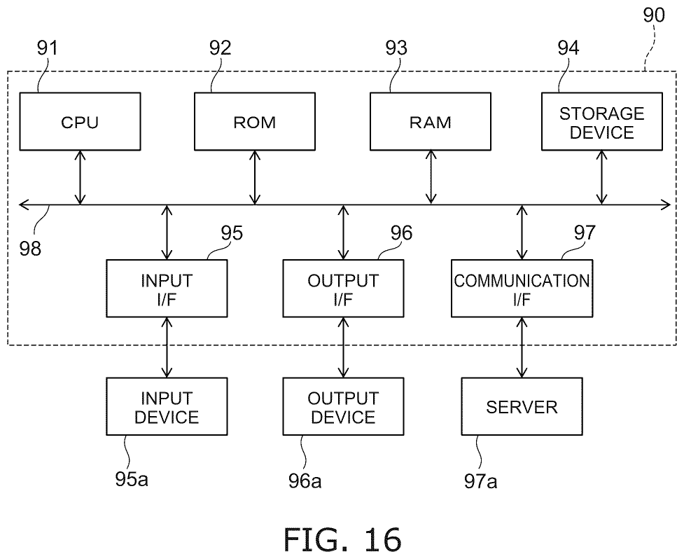

FIG. 16 is a schematic diagram showing a hardware configuration.

For example, a computer 90 shown in FIG. 16 is used as each of the control device 20, the processing device 40, and the terminal device 50. The computer 90 includes a CPU 91, a ROM 92, a RAM 93, a storage device 94, an input interface 95, an output interface 96, and a communication interface 97.

The ROM 92 stores a program for controlling operations of the computer 90. In the ROM 92, a program necessary for causing the computer 90 to implement the above-described processes is stored. The RAM 93 functions as a storage area to which the programs stored in the ROM 92 are loaded.

The CPU 91 includes a processing circuit. The CPU 91 uses the RAM 93 as a work memory to execute programs stored in at least either the ROM 92 or the storage device 94. While executing the programs, the CPU 91 controls each component via a system bus 98 to perform various processes.

The storage device 94 stores data necessary for execution of programs and data obtained as a result of execution of programs.

The input interface (I/F) 95 is capable of connecting the computer 90 with an input device 95a. The input I/F 95 is, for example, a serial bus interface, such as USB. The CPU 91 can read various types of data from the input device 95a via the input I/F 95.

The output interface (I/F) 96 is capable of connecting the computer 90 with an output device 96a. The output I/F 96 is a video output interface, such as Digital Visual Interface (DVI) or High-Definition Multimedia Interface (HDMI (registered trademark)). The CPU 91 can transmit data to the output device 96a via the output I/F 96 to make the output device 96a display a user interface.

The communication interface (I/F) 97 is capable of connecting a server 97a outside the computer 90 with the computer 90. The communication I/F 97 is, for example, a network card, such as a LAN card. The CPU 91 can read various types of data from the server 97a via the communication I/F 97.

The storage device 94 includes one or more selected from among a hard disk drive (HDD) and a solid state drive (SSD). The input device 95a includes one or more selected from among a mouse, a keyboard, a microphone (voice input), and a touch pad. The output device 96a includes one or more selected from among a monitor, a projector, a printer, and a speaker. A device, such as a touch panel, having the functions of both the input device 95a and the output device 96a may be used.

Each process performed by the control device 20, the processing device 40, or the terminal device 50 may be implemented by one computer 90 or a plurality of computers 90 cooperating with each other.

Processing of various types of data described above may be recorded, as a program that can be executed by a computer, on a magnetic disk (examples of which include a flexible disk and a hard disk), an optical disk (examples of which include a CD-ROM, a CD-R, a CD-RW, a DVD-ROM, a DVD+R, and DVD+RW), a semiconductor memory, or another non-transitory computer-readable storage medium.

For example, information recorded on a recording medium can be read by a computer (or an embedded system). The recording medium can have any record format (storage format). For example, the computer reads a program from the recording medium and causes the CPU to execute instructions described in the program, on the basis of the program. The computer may obtain (or read) the program through a network.

Embodiments of the invention include the following features.
Feature 1

A processing device, configured to:
obtain a plurality of first events indicating that a holding part of a handling robot has passed through respective predetermined passing-through positions;
obtain a plurality of images of the handling robot;
identify, when obtaining a second event indicating an abnormality in the handling robot, a first period that is between two of the plurality of first events and includes occurrence timing of the second event, or a second period that is from one of the plurality of first events immediately before the occurrence timing to the occurrence timing; and
extract at least one of the plurality of images obtained in the first period or the second period from the plurality of images.
Feature 2

The processing device according to feature 1, wherein
a plurality of areas are respectively photographed by a plurality of photographing devices, and
the processing device is further configured to,
   when obtaining the second event, estimate an area, among the plurality of areas, in which the holding part is present at the occurrence timing, and
   extract an image from one of the plurality of photographing devices that photographs the estimated area.
Feature 3

The processing device according to feature 1, wherein
a plurality of areas are respectively photographed by a plurality of photographing devices, and
the processing device is further configured to,
   when obtaining a second event indicating a drop of an item held by the holding part, estimate an area, among the plurality of areas, in which the dropping item is present, and
   extract an image from one of the plurality of photographing devices that photographs the estimated area.
Feature 4

The processing device according to feature 1, wherein
a plurality of areas are photographed by a plurality of respective photographing devices,
a plurality of sections are set in an installation place of the handling robot,
each of the plurality of sections is associated with any of the plurality of photographing devices, and
the processing device is further configured to,
   when obtaining a second event indicating a drop of an item held by the holding part, determine a section, among the plurality of sections, into which the item has dropped, and
   extract an image from one of the plurality of photographing devices that is associated with the determined section.

### Feature 5

The processing device according to any one of features 1 to 4, wherein
the second event is generated when an item held by the holding part has dropped or when the holding part has come into contact with an object other than the item to be held, and
the processing device is further configured to,
   when the item has dropped, extract the image obtained in the first period, and
   when the holding part has come into contact with the object, extract the image obtained in the second period.
Feature 6

A processing system comprising:
the processing device according to any one of features 1 to 5; and
a terminal device connected to the processing device via a network,
the processing device being configured to transmit the extracted image to the terminal device.

### Feature 7

The processing system according to feature 6, further comprising:
a photographing device configured to obtain the plurality of images by photographing the handling robot.

### Feature 8

A handling system comprising:
the processing device according to any one of features 1 to 5;
a photographing device configured to obtain the plurality of images by photographing the handling robot;
the handling robot; and
a control device configured to control the handling robot so as to make the holding part pass through the passing-through positions.
Feature 9

The handling system according to feature 8, further comprising:
a terminal device connected to the processing device via a network, wherein
the terminal device is configured to
   display a user interface including the extracted image, an item conveyed by the handling robot, and a correction section for inventory information of the item, and
   change the inventory information of the item in accordance with input to the correction section from a user.

### Feature 10

The handling system according to feature 8, further comprising:
a terminal device connected to the processing device via a network, wherein
the terminal device is configured to
   display a user interface including the extracted image and an operation section configured to initialize a motion of the handling robot, and
   initialize the motion of the handling robot in accordance with input to the operation section from a user.

### Feature 11

The handling system according to any one of features 8 to 10, wherein
the control device is further configured to
   obtain item data at least one selected from the group of consisting a size of an item to be held, a form of the item, a weight of the item, and a material of the item, and
   change, in accordance with the item data, at least one selected from the group consisting of a holding power for the item, a holding method for the item, and a conveyance speed for the item.

### Feature 12

The handling system according to any one of features 8 to 11, wherein
the handling robot is a picking robot.

### Feature 13

A processing method for causing a computer to:
obtain a plurality of first events indicating that a holding part of a handling robot has passed through respective predetermined passing-through positions;
obtain a plurality of images of the handling robot;
identify, when obtaining a second event indicating an abnormality in the handling robot, a first period that is between two of the plurality of first events and includes an occurrence timing of the second event, or a second period that is from one of the plurality of first events immediately before the occurrence timing to the occurrence timing; and
extract at least one of the plurality of images obtained in the first period or the second period from the plurality of images.
Feature 14

The processing method according to feature 13, wherein
the second event is generated when an item held by the holding part has dropped or when the holding part has come into contact with an object other than the item to be held,
the computer is further configured to, when the item has dropped, extract the image obtained in the first period, and
the computer is further configured to, when the holding part has come into contact with the object, extract the image obtained in the second period.

### Feature 15

The processing method according to feature 13 or 14, wherein
a plurality of areas are photographed by a plurality of respective photographing devices,
a plurality of sections are set in an installation place of the handling robot,
each of the plurality of sections is associated with any of the plurality of photographing devices, and
the computer is further configured to
   when obtaining a second event indicating a drop of an item held by the holding part, determine a section, among the plurality of sections, into which the item has dropped, and
   extract an image from one of the plurality of photographing devices that is associated with the determined section.

### Feature 16

A program for causing the computer to perform the processing method according to any one of features 13 to 15.
Feature 17

A storage medium storing the program according to feature 16.

According to the embodiment described above, a processing device, a processing system, a handling system, a processing method, a program, or a storage medium that, upon the occurrence of an abnormality in the handling robot 10, enables easy checking of the state of, for example, the handling robot 10 or an item.

In the specification, “or” indicates that “at least one or more” of items enumerated in the sentence can be adopted.

Although some embodiments of the invention have been described above, these embodiments have been presented by way of example and are not intended to limit the scope of the invention. These novel embodiments can be implemented in a variety of other forms, and various omissions, substitutions, changes, and the like can be made without departing from the gist of the invention. Such embodiments or their modifications fall within the scope of the invention as defined in the claims and their equivalents as well as within the scope and gist of the invention. Further, the above-described embodiments can be implemented in combination with each other.

What is claimed is:

1. A processing device, configured to:
obtain a plurality of first events indicating that a holding part of a handling robot has passed through respective predetermined passing-through positions;
obtain a plurality of images of the handling robot;
identify, when obtaining a second event indicating an abnormality in the handling robot, a first period that is between two of the plurality of first events and includes occurrence timing of the second event, or a second period that is from one of the plurality of first events immediately before the occurrence timing to the occurrence timing; and
extract at least one of the plurality of images obtained in the first period or the second period from the plurality of images.

2. The processing device according to claim 1, wherein
a plurality of areas are respectively photographed by a plurality of photographing devices, and
the processing device is further configured to,
when obtaining the second event, estimate an area, among the plurality of areas, in which the holding part is present at the occurrence timing, and
extract an image from one of the plurality of photographing devices that photographs the estimated area.

3. The processing device according to claim 1, wherein
a plurality of areas are respectively photographed by a plurality of photographing devices, and
the processing device is further configured to,
when obtaining a second event indicating a drop of an item held by the holding part, estimate an area, among the plurality of areas, in which the dropping item is present, and
extract an image from one of the plurality of photographing devices that photographs the estimated area.

4. The processing device according to claim 1, wherein
a plurality of areas are photographed by a plurality of respective photographing devices,
a plurality of sections are set in an installation place of the handling robot,
each of the plurality of sections is associated with any of the plurality of photographing devices, and
the processing device is further configured to,
when obtaining a second event indicating a drop of an item held by the holding part, determine a section, among the plurality of sections, into which the item has dropped, and
extract an image from one of the plurality of photographing devices that is associated with the determined section.

5. The processing device according to claim 1, wherein
the second event is generated when an item held by the holding part has dropped or when the holding part has come into contact with an object other than the item to be held, and
the processing device is further configured to,
when the item has dropped, extract the image obtained in the first period, and
when the holding part has come into contact with the object, extract the image obtained in the second period.

6. A processing system comprising:
the processing device according to claim 1; and
a terminal device connected to the processing device via a network,
the processing device being configured to transmit the extracted image to the terminal device.

7. The processing system according to claim 6, further comprising:
a photographing device configured to obtain the plurality of images by photographing the handling robot.

8. A handling system comprising:
the processing device according to claim 1;
a photographing device configured to obtain the plurality of images by photographing the handling robot;
the handling robot; and
a control device configured to control the handling robot so as to make the holding part pass through the passing-through positions.

9. The handling system according to claim 8, further comprising:
a terminal device connected to the processing device via a network, wherein
the terminal device is configured to
display a user interface including the extracted image, an item conveyed by the handling robot, and a correction section for inventory information of the item, and
change the inventory information of the item in accordance with input to the correction section from a user.

10. The handling system according to claim 8, further comprising:
a terminal device connected to the processing device via a network, wherein
the terminal device is configured to
display a user interface including the extracted image and an operation section configured to initialize a motion of the handling robot, and
initialize the motion of the handling robot in accordance with input to the operation section from a user.

11. The handling system according to claim 8, wherein
the control device is further configured to
obtain item data at least one selected from the group of consisting a size of an item to be held, a form of the item, a weight of the item, and a material of the item, and
change, in accordance with the item data, at least one selected from the group consisting of a holding power for the item, a holding method for the item, and a conveyance speed for the item.

12. The handling system according to claim 8, wherein
the handling robot is a picking robot.

13. A processing method for causing a computer to:
obtain a plurality of first events indicating that a holding part of a handling robot has passed through respective predetermined passing-through positions;
obtain a plurality of images of the handling robot;
identify, when obtaining a second event indicating an abnormality in the handling robot, a first period that is between two of the plurality of first events and includes an occurrence timing of the second event, or a second period that is from one of the plurality of first events immediately before the occurrence timing to the occurrence timing; and
extract at least one of the plurality of images obtained in the first period or the second period from the plurality of images.

14. The processing method according to claim 13, wherein
the second event is generated when an item held by the holding part has dropped or when the holding part has come into contact with an object other than the item to be held,
the computer is further configured to, when the item has dropped, extract the image obtained in the first period, and
the computer is further configured to, when the holding part has come into contact with the object, extract the image obtained in the second period.

15. The processing method according to claim 13, wherein
a plurality of areas are photographed by a plurality of respective photographing devices,
a plurality of sections are set in an installation place of the handling robot,
each of the plurality of sections is associated with any of the plurality of photographing devices, and
the computer is further configured to
when obtaining a second event indicating a drop of an item held by the holding part, determine a section, among the plurality of sections, into which the item has dropped, and
extract an image from one of the plurality of photographing devices that is associated with the determined section.

16. A non-transitory computer-readable storage medium storing a program for causing the computer to perform the processing method according to claim 13.
